(19) United States
(12) Patent Application Publication
(10) Pub. No.: US 2003/0198511 A1
(43) Pub. Date: Oct. 23, 2003

(54) Latch for temporarily holding canister levers in a locked position

(76) Inventor: Tina M. Reintjes, Wichita, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/124,674

(22) Filed: Apr. 17, 2002

(51) Int. Cl. B25G 3/18; F16B 21/00

(52) U.S. Cl. 403/326

(57) ABSTRACT

A latch for temporarily holding canister levers in a locked position. The latch includes a back member received by a front of the canister, and a top member formed integrally with a top of the back member. The top member receives the levers and is capable of holding the levers in the locked position. The latch is temporarily deflected downward when the levers are being moved into the locked position. The latch includes an incorporated spring for returning the latch to its original position once the levers are received within the top member in the locked position.

### BACKGROUND OF THE INVENTION

1. Technical Field:

The present invention is directed generally toward data processing storage devices, and more particularly to a latch for temporarily holding canister levers in a locked position where the canister is for holding an electronic circuit card and may be removable installed in a storage system chassis.

2. Description of the Related Art:

Electronic circuit cards may be secured within a chassis in a data processing system using a canister. For example, in some data storage systems, a storage controller card is secured within a canister. The canister is then removably secured within a storage chassis. The canister may be removably secured using a pair of levers which are secured to the canister. The canister is locked into placed in the storage chassis when the levers are held in a locked position.

In the prior art, the levers have been held in their locked position using a cantilevered latch. FIG. 10 is a front isometric view of a canister 100 without levers in accordance with the prior art. FIG. 11 is a front isometric view of a latch 102 in accordance with the prior art that may be used to lock levers to the canister of FIG. 10. The prior art latch is installed in the canister by sliding top portion 106 of latch 102 into the top t-shaped cutout 104 of canister 100. The nub 108 included on the back end of latch 102 holds the latch in place. The front portion 110 of the latch would extend below portion 114 of canister 100 and through the large front slot 112 in canister 100.

In order to release levers from canister 100, force would be applied to the front end 110 of latch 102, causing latch 102 to deflect down within slot 112 and thus release the levers.

A large amount of radiated emissions escape through slot 112 when the prior art latch is used.

### SUMMARY OF THE INVENTION

A latch for temporarily holding canister levers in a locked position. The latch includes a back member received by a front of the canister, and a top member formed integrally with a top of the back member. The top member receives the levers and is capable of holding the levers in the locked position. The latch is temporarily deflected downward when the levers are being moved into the locked position. The latch includes an incorporated spring for returning the latch to its original position once the levers are received within the top member in the locked position. The latch is secured to the front of the canister using a small slot in the front of the canister.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a side view of a latch in accordance with the present invention;

FIG. 2 is a front view of a latch in accordance with the present invention;

FIG. 3 is a back view of a latch in accordance with the present invention;

FIG. 4 is a back isometric view of a latch in accordance with the present invention;

FIG. 5 is a front isometric view of a latch in accordance with the present invention;

FIG. 6 is a front isometric view of a canister without levers in accordance with the present invention;

FIG. 7 is a front isometric view of a canister having a latch secured to the canister and having levers in an unlocked position in accordance with the present invention;

FIG. 8 is a top view of a canister having a latch secured to the canister and having levers in an unlocked position in accordance with the present invention;

FIG. 9 is a front isometric view of a canister having a latch secured to the canister and having levers secured in a lock position in accordance with the present invention;

FIG. 10 is a front isometric view of a canister without levers in accordance with the prior art; and

FIG. 11 is a front isometric view of a latch in accordance with the prior art.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

The present invention is a latch for holding levers in a canister in a locked position. The latch reduces the EMI that is released from the canister because the latch requires only a small mounting slot in the canister. The latch is preferably a single-piece manufacture.

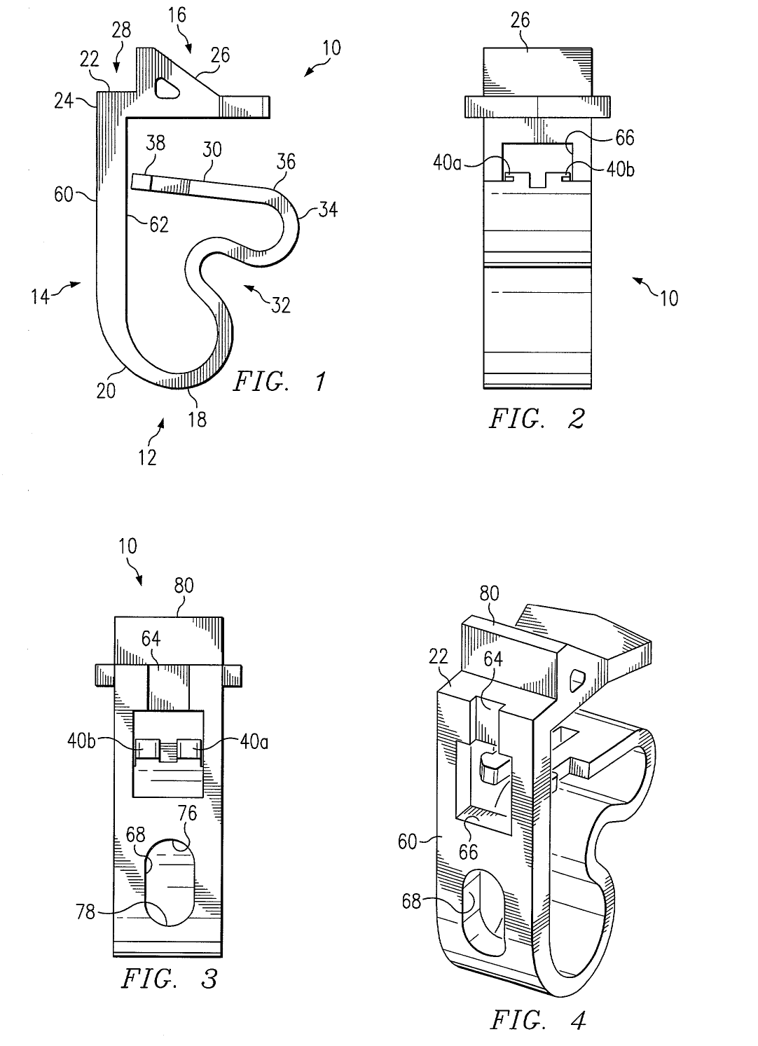

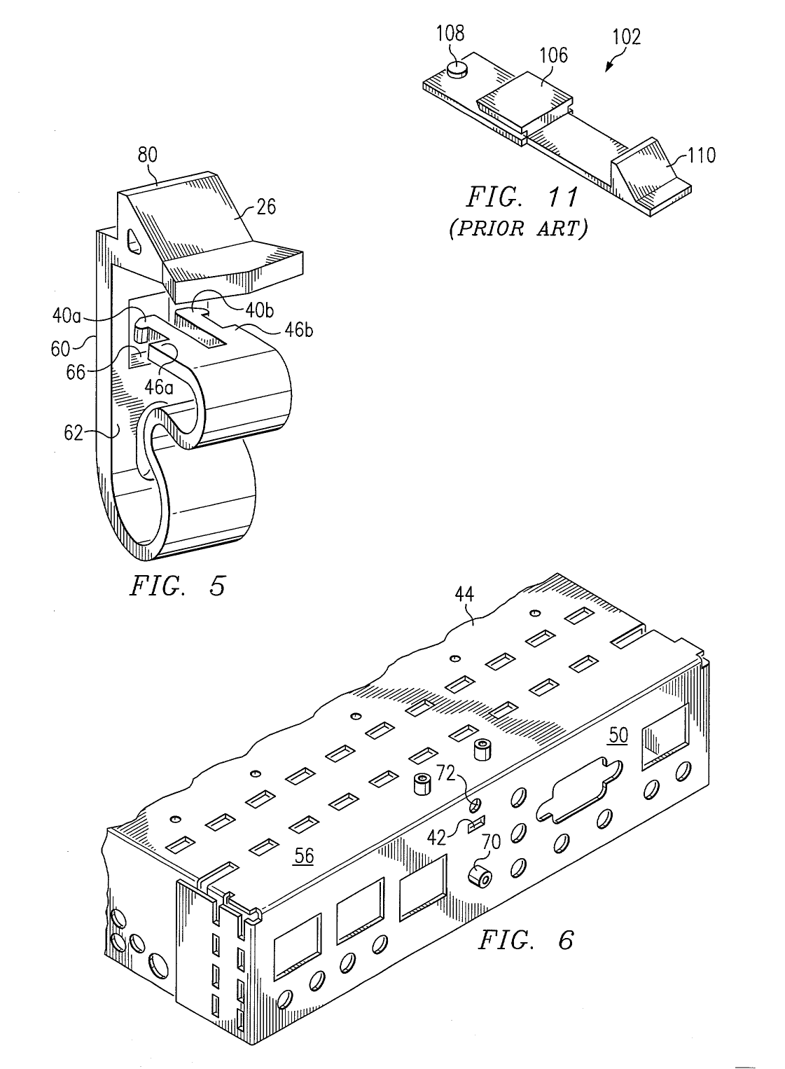

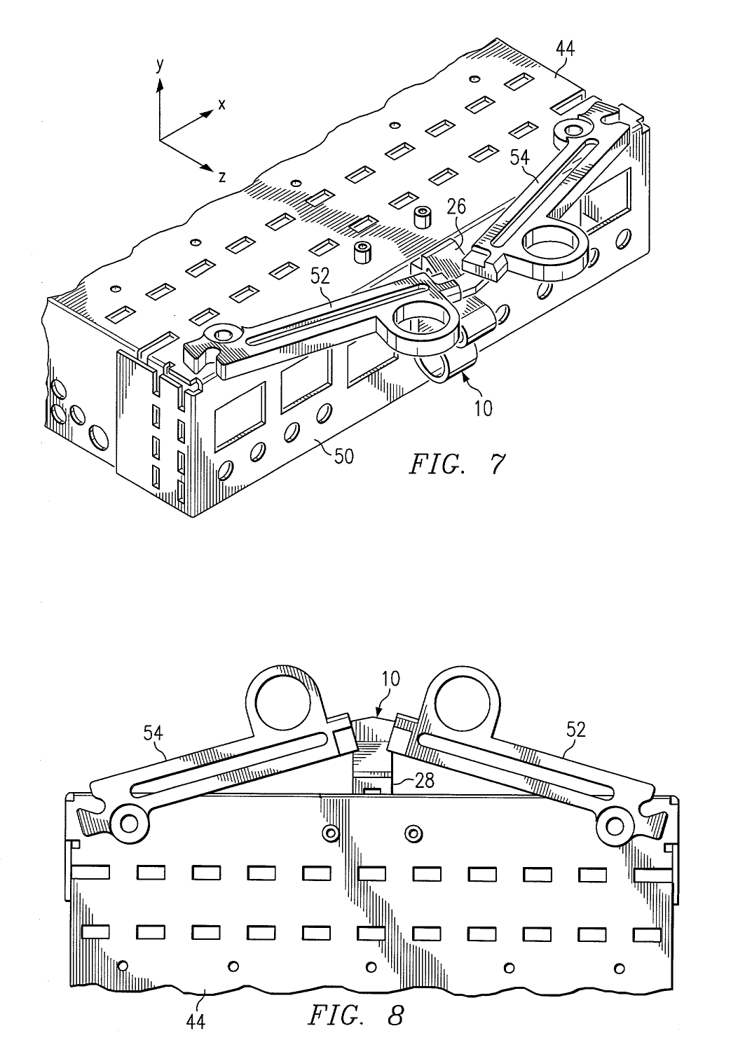

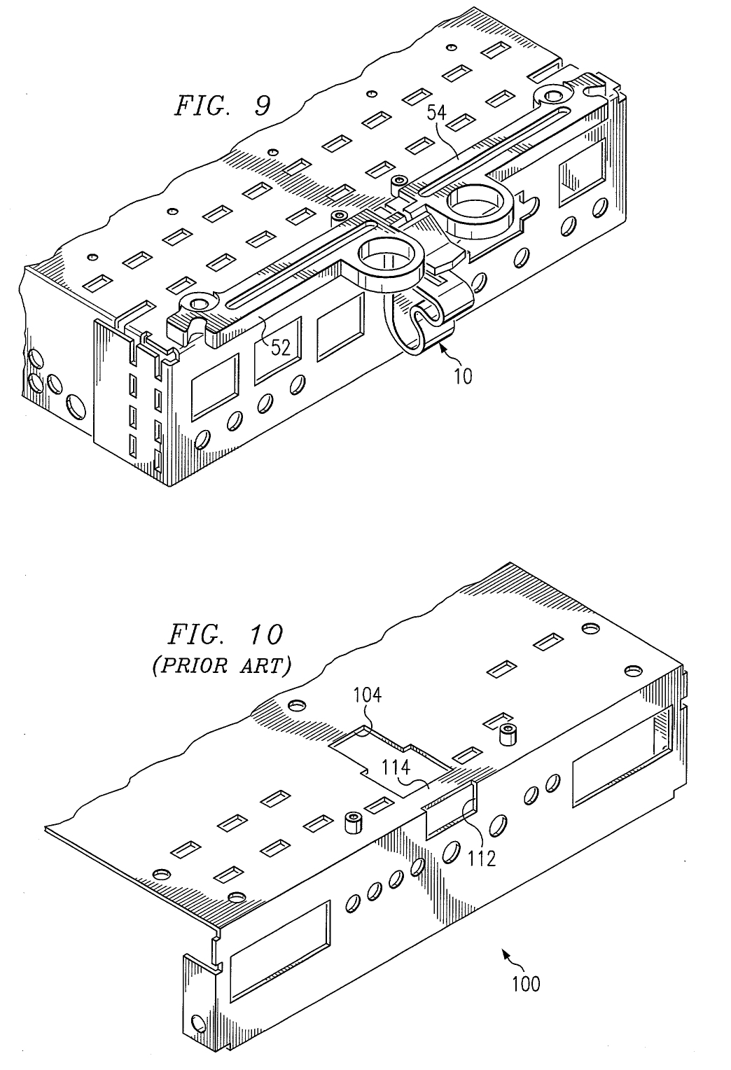

FIG. 1 is a side view of a latch in accordance with the present invention. FIG. 2 is a front view of a latch in accordance with the present invention. FIG. 3 is a back view of a latch in accordance with the present invention. FIG. 4 is a back isometric view of a latch in accordance with the present invention. FIG. 5 is a front isometric view of a latch in accordance with the present invention. FIG. 6 is a front isometric view of a canister without levers in accordance with the present invention. FIG. 7 is a front isometric view of a canister having a latch secured to the canister and having levers in an unlocked position in accordance with the present invention. FIG. 8 is a top view of a canister having a latch secured to the canister and having levers in an unlocked position in accordance with the present invention. And, FIG. 9 is a front isometric view of a canister having a latch secured to the canister and having levers secured in a lock position in accordance with the present invention.

Latch 10 includes a front member 12, a back member 14, and a top member 16. A bottom portion 18 of front member 12 is secured to a bottom portion 20 of back member 14. A front portion 22 of top member 16 is secured to a top portion 24 of back member 14.

Top member 16 includes a ramped surface 26 and a recess 28.

Front member 12 includes a top portion 30 and a continuous S-shaped lower portion 32 which acts as an incorporated spring as described below. One end 18 of lower portion 32 is formed integrally with bottom portion 20 of back member 14. The other end 34 of lower portion 32 is formed integrally with a first end 36 of top portion 30. Second end of 38 top portion 30 includes a pair of tapered hooks 40a and 40b which may be received within a mounting slot 42 in the canister 44. Hooks 40a, 40b are formed integrally with second end 38 of top portion 30 using a pair of shoulders 46a and 46b. Shoulders 46a, 46b prohibit movement of latch 10 in the z-axis direction.

Mounting slot 42 is preferably small in order to limit the EMI radiation that will leak from canister 44 through its openings. For example, slot 42 will preferably be less than 0.25 inches in any dimension. Canister 44 has a generally flat, vertical front face 50 to which latch 10 may be removably secured. Two pivoting levers 52 and 54 are secured to the top 56 of canister 44 . In order to remove canister 44 from a chassis, levers 52, 54 are rotated away from canister 44. In order to lock canister 44 into place in a chassis, levers 52, 54 are rotated toward canister 44. Latch 10 is used to hold levers 52, 54 in a locked position, depicted by FIG. 9.

Back member 14 of latch 10 includes a back face 60 and a front face 62. Back member 14 is generally flat and vertical and includes an upper recess 64, a middle slot 66 which extends through back member 14, and a lower slot 68 which extends through back member 14. When latch 10 is secured to canister 44, back face 60 of back member 14 rests against front face 50 of canister 44.

In order to lock levers 52, 54 into place, latch 10 is first removably secured to canister 44 by placing back surface 60 against front surface 50 of canister 44. An alignment pin 70 on front face 50 of canister 44 is received within lower slot 68 and a nub 72, also on front 50 of canister 44, is received within upper recess 64. Alignment pin 70 guides lower slot 68 and prohibits movement of latch 10 in the x-axis direction. Front face 34 of lower portion 32 is then pushed in the z-axis direction. When front face 34 is pushed, hooks 40a, 40b are pushed through middle slot 66 of latch 10 toward front face 50 of canister 44. When hooks 40a, 40b reach front face 50, hooks 40a, 40b work against small mounting slot 42 and deflect inward, toward each other. Hooks 40a, 40b then squeeze through slot 42. Once hooks 40a, 40b have been pushed through slot 42, hooks 40a, 40b return to their original non-deflected positions and hold latch 10 onto front face 40. Hooks 40a, 40b prohibit movement of latch 10 in the x-axis and z-axis directions, while permitting movement of latch 10 in the y-axis direction. When alignment pin 70 is received within lower slot 68, alignment pin 70 guides movement of latch 10 in the y-axis. Top recess 64 acts as a guide for nub 72. A top 76 and bottom 78 of lower slot 68 provide boundaries for movement of latch 10 in the y-axis direction.

Once latch 10 is temporarily secured to front face 50 of canister 44, levers 52, 54 maybe rotated toward front face 50 of canister 44 in order to be secured in a locked position. As each lever is rotated toward front face 50, the lever will reach ramped top surface 26 of top member 16. As the lever is pushed toward front face 50, the lever pushes on ramped top surface 26 which causes back member 14 to be deflected downward in the y-axis direction. While back member 14 is being deflected downward, hooks 40a, 40b remain locked in place in middle slot 42 causing s-shaped portion 32 of front member 12 to uncoil. Once the lever has been pushed past a top 80 of ramped surface 26, the lever is received within recess 28. When the lever is received within recess 28, s-shaped portion 32 regains its original shape causing back member 14 to spring back upward in the y-axis direction. The lever is thus locked into place.

Although the movement of only one lever has been described, typically both levers will be moved simultaneously. Both levers are moved generally simultaneously past top 80 of ramped surface 26, and then received within recess 28.

In order to remove canister 44 from its chassis, levers 52, 54 must be moved from their locked position and out away from canister 44. In order to release levers 52, 54, back member 14 is pushed downward by pushing down on top member 16. While back member 14 is deflected downward, levers 52, 54 may be moved out of recess 28 and away from canister 44. Once levers 52, 54 have been released from recess 28, back member 14 regains its original non-deflected position.

Latch 10 may be removed from canister 44 by pushing shoulders 46a, 46b in order to deflect hooks 40a, 40b. While hooks 40a, 40b are deflected, latch 10 may be removed by pulling hooks 40a, 40b out of middle slot 66.

Latch 10 is preferably a single-piece manufacture. As described above, latch 10 includes an incorporated spring. Hooks 40a, 40b limit movement of latch 10 in the x-axis and z-axis direction while permitting movement in the y-axis direction. S-shaped portion 32 in cooperation with middle slot 66 and lower slot 68 permit temporary movement of latch 10 in the downward direction when force is applied to top member 16. When this force is released, s-shaped portion 32 works to regain its original, at-rest position which causes latch 10 to spring back to its original, at-rest position.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A latch for temporarily holding canister levers in a locked position, said latch comprising:
a back member received by a front face of said canister;
a top member formed integrally with a top of said back member, said top member receiving said levers and capable of holding said levers in said locked position;
said latch being temporarily deflected downward when said levers are being moved into said locked position; and
said latch including an incorporated spring for returning said latch to an original position once said levers are received within said top member in said locked position.

2. The latch according to claim 1, further comprising:
a bottom of a front member formed integrally with a bottom of said back member, said front member including said incorporated spring.

3. The latch according to claim 1, further comprising:
a bottom of a front member formed integrally with a bottom of said back member, said front member including said incorporated spring, said front member being generally a continuous s-shape.

4. The latch according to claim 1, further comprising:
a front member including a top portion and a continuous s-shaped bottom portion, a first end of said bottom portion being formed integrally with a bottom of said back member, said bottom portion being an incorporated spring.

5. The latch according to claim 1, further comprising:
a front member including a top portion and a continuous s-shaped bottom portion, a first end of said bottom portion being formed integrally with a bottom of said back member;
said bottom portion being an incorporated spring;
said top portion including a pair of hooks for securing said latch to said canister.

6. The latch according to claim 1, further comprising: said top member including a recess for holding said levers in said locked position and a ramped surface.

7. The latch according to claim 1, further comprising:
a front member including a top portion and a continuous s-shaped bottom portion, a first end of said bottom portion being formed integrally with a bottom of said back member,;
said bottom portion being an incorporated spring;
said top portion including a pair of hooks for securing said latch to said canister;
said front face of said canister including a slot;
said back member including a slot through said back member, said pair of hooks capable of being pushed through said slot in said back member and being removably secured within said slot in said front face; and
said front member including a pair of shoulders, said pair of shoulders prohibiting movement of said latch in said z-axis direction.

8. The latch according to claim 1, further comprising:
said back member including a lower slot;
said canister including an alignment pin on said face of said canister; and
said alignment pin being received within said lower slot in said back member when said latch is secured to said canister.

9. The latch according to claim 8, further comprising:
said alignment pin for limiting movement of said latch in an x-axis direction.

10. A method for temporarily holding canister levers in a locked position utilizing a latch, said method comprising the steps of:
temporarily securing said latch to said canister by temporarily securing a back member of said latch to a front face of said canister;
moving said levers over a top member of said latch until said levers are held in a locked position by said top member, said top member being formed integrally with a top of said back member;
temporarily deflecting said latch downward when said levers are being moved into said locked position; and
returning said latch to an original position utilizing an incorporated spring in said latch once said levers are received within said top member in said locked position.

11. The method according to claim 10, further comprising the step of:
returning said latch to an original position utilizing an incorporated spring in said latch once said levers are received within said top member in said locked position, said latch including a bottom of a front member formed integrally with a bottom of said back member, said front member including said incorporated spring.

12. The method according to claim 10, further comprising the step of:
returning said latch to an original position utilizing an incorporated spring in said latch once said levers are received within said top member in said locked position, said latch including a bottom of a front member formed integrally with a bottom of said back member, said front member including said incorporated spring, said front member being generally a continuous s-shape.

13. The method according to claim 10, further comprising the step of:
returning said latch to an original position utilizing an incorporated spring in said latch once said levers are received within said top member in said locked position, said latch including a front member including a top portion and a continuous s-shaped bottom portion, a first end of said bottom portion being formed integrally with a bottom of said back member, said bottom portion being an incorporated spring.

14. The method according to claim 10, further comprising: including in said latch a front member including a top portion and a continuous s-shaped bottom portion, a first end of said bottom portion being formed integrally with a bottom of said back member, said bottom portion being an incorporated spring, and said top portion including a pair of hooks for securing said latch to said canister.

15. The method according to claim 10, wherein said step of moving said levers over a top member of said latch until said levers are held in a locked position by said top member further comprises the step of:
moving said levers over a ramped surface of a top member of said latch until said levers are received by a recess included in said top member, said levers being held in a locked position by said recess of said top member.

16. The method according to claim 10, further comprising the steps of:
including in said latch a front member including a top portion and a continuous s-shaped bottom portion, a first end of said bottom portion being formed integrally with a bottom of said back member, said bottom portion being an incorporated spring; and
pushing a pair of hooks included in said top portion of said front member through a slot in said back member and then through a slot included in said front face of said canister, said front member including a pair of shoulders, said pair of shoulders prohibiting movement of said latch in said z-axis direction once said pair of hooks of received through said slot in said front face of said canister.

17. The method according to claim 10, further comprising the step of:
receiving an alignment pin included on said face of said canister within a lower slot included in said back member when said latch is secured to said canister.

18. The method according to claim 17, further comprising the step of:
limiting movement of said latch in an x-axis direction utilizing said alignment pin when said alignment pin is received within said lower slot.
